(19) United States
(12) Patent Application Publication
(10) Pub. No.: US 2007/0100700 A1
(43) Pub. Date: May 3, 2007

(54) Parking space payment system and method

(76) Inventor: Damien Mandy, Fontain (FR)

Correspondence Address: SOFER & HAROUN LLP., 317 MADISON AVENUE, SUITE 910, NEW YORK, NY, 10017, US

(21) Appl. No.: 10/531,404

(22) PCT Filed: Jul. 18, 2003
(86) PCT No.: PCT/EP03/77944

§ 371 Date: Nov. 22, 2006

(30) Foreign Application Priority Data
Oct. 30, 2002 (FR) 02/13631

(51) Int. Cl. G06Q 20/00

(52) U.S. Cl. 705/17

(57) ABSTRACT

A parking space payment method and system includes suitable payment means which enable the user to pay a given amount in order to use an authorised parking space for a corresponding length of time. The aforementioned payment means co-operate with suitable processing and communication means in order to provide the user with a specific transaction code. The payment means also cooperates with processing and input means which enable the user to enter the code from a previous transaction, such as to increase the authorised parking duration by any authorised time remaining from the time authorised during the earlier transaction.

The present invention relates to a method of paying for a parking space. The present invention also relates to a system for implementing the method.

The international application Wo 96/11453 discloses a system for paying for a chargeable parking space using a GSM or other mobile telephone network and in which a user employs his mobile telephone to call a parking server to indicate the selected parking area, to provide an identifier of the vehicle, such as the registration number, and, where applicable, to provide a personal identification number. The parking server stores the data from the call and the time at which the parking period begins.

When the user leaves the parking place, he calls the parking server again to inform it of his departure. The server is able to calculate the charge to be paid by the user from the parking time and the scale of parking charges applicable in the parking area and to bill for parking either directly or via the mobile telephone operator.

The above prior art system is supervised by operatives equipped with portable devices enabling them to consult the parking server by telephone to find out if parked vehicles, identified by their registration number in particular, have been correctly registered with the server.

Patent application WO 00/55816 filed by the present applicant discloses a system for paying for parking by means of a mobile telephone in systems using parking terminals.

U.S. Pat. No. 6,230,868 describes payment based on numbered parking spaces, which simplifies supervision by the operatives. Payments are linked to parking spaces identified unambiguously by numbers, and it is easy to check the status of a parking space (paid for or not paid for), regardless of the payment means used (cash, payment card or mobile telephone) and regardless of the supervisory means employed (ticket, parking terminal display, mobile telephone, etc.). Accordingly, in the case of payment by mobile telephone, it is easy to have the numbers of the parking spaces appear in the same order on supervisory operative terminals as on the parking site. Moreover, it is no longer necessary for the user to enter an identifier characteristic of his vehicle using his telephone, the supervisory operatives merely verifying if an occupied space has been paid for.

Two different modes of payment may be used in the case of payment by telephone. In the first mode, payment is started by a first call to the system and stopped by a second call to the same system; in the second mode a predefined period is paid for. The first payment mode has the major disadvantage of necessitating two calls. As for the second, problems arise in applying it to a parking system based on numbered parking spaces.

Three approaches may be envisaged in the event of a new request for payment for a given parking space:

In the “Full Reset” mode, the previous transaction for the same space is deleted. Any new payment for a space cancels the previous transaction, without allowing for any remaining parking time. However, this approach has risks for users. If a second user erroneously pays for a space already occupied by and paid for by a first user, and if the new amount paid allows parking for a shorter period than the remaining time, the parking time of the first user is reduced, despite the payment originally made.

In the “Best Time” mode, referring to the “best time” between the remaining time and the time paid for, when a new payment is made, the terminal verifies which is the more favorable parking expiry time: that registered beforehand, as a result of the previous transaction for the same space, or that corresponding to the transaction that has just been validated. This prevents a new transaction “canceling” the previous transaction, but obliges a user wishing to park for longer without paying twice for the overlap period to wait for the end of the first parking period before paying for his additional time.

In the “Add Time” mode, time paid for is added to remaining time. When a new payment is made, after validation of the transaction, the new time paid for is added to any remaining time from the previous transaction and the result defines a new authorized parking expiry time. This prevents a new transaction “canceling” the previous transaction. It also enables a user to extend his parking time without waiting for the end of the initial time and with no excess cost. It nevertheless has the disadvantage that an arriving user obtains the full benefit of any parking rights of the previous user, for which he has not paid, which mitigates against the cost effectiveness of the parking service parking policy. It also has a negative impact in terms of parking management since, if there is a maximum authorized time, it enables a user to obtain an authorized parking time greater than the maximum authorized time.

The present invention therefore aims to solve the problems referred to above by proposing a simple and original method of paying for a parking space.

The method of the invention of paying for a parking space uses a payment system including appropriate payment means whereby the user pays a given amount to benefit from a corresponding authorized parking time.

According to the invention, the method of paying for a parking space is characterized in that said payment means cooperate with appropriate processing and communication means for supplying to said user a code specific to the transaction and in that said payment means cooperate with appropriate processing and input means whereby the user can enter the code of an earlier transaction and thereby increase said authorized parking time by any residual authorized time corresponding to the authorized time linked to said earlier transaction.

According to another feature of the parking space payment method of the present invention, said parking space is identified by an appropriate number and the user must enter said number during the payment operation using the appropriate input and processing means cooperating with said payment means.

According to another feature of the parking space payment method of the present invention, said number is used by said processing means to generate said specific code of the transaction.

According to another feature of the parking space payment method of the present invention, said authorized parking time is increased by any remaining authorized time corresponding to the authorized time linked to said earlier transaction code entered by the user only if said earlier transaction relates to the same parking space.

According to another feature of the parking space payment method of the present invention, the authorized time corresponding to a given amount paid by a user is equal to the greater of the following times: the time directly related to said payment, as defined in particular by an appropriate table of charges, and any remaining authorized time corresponding to the previous authorized time relating to said parking space.

According to another feature of the parking space payment method of the present invention, the authorized time corresponding to a given amount paid by a user is equal to the greater of the following times: the time directly related to said payment as defined in particular by an appropriate table of charges and any remaining authorized times corresponding to preceding authorized times relating to said parking space.

According to another feature of the parking space payment method of the present invention, only the time directly related to said payment as defined in particular by an appropriate table of charges is communicated to the user by appropriate communication means cooperating with said payment means.

According to another feature of the parking space payment method of the present invention, the authorized parking time after the user enters the code of an earlier transaction is equal to the greater of the following times: the time directly related to said payment, as defined in particular by an appropriate table of charges, plus any remaining authorized time corresponding to the authorized time linked to said earlier transaction, and any remaining authorized time corresponding to the previous authorized time relating to said parking space.

According to another feature of the parking space payment method of the present invention, the authorized parking time after the user enters the code of an earlier transaction is equal to the greater of the following times: the time directly related to said payment, as defined in particular by an appropriate table of charges, plus any remaining authorized time corresponding to the authorized time linked to said earlier transaction, and any remaining authorized times corresponding to previous authorized times relating to said parking space.

The present invention also provides a parking space payment system for implementing the above method.

The parking space payment system of the invention includes appropriate payment means whereby a user pays a given amount to benefit from a corresponding authorized parking time.

According to the invention, the system is characterized in that said payment means cooperate with appropriate processing and communication means to supply to said user a code specific to the transaction and said payment means cooperate with appropriate processing and input means whereby the user can enter the code of an earlier transaction and thereby increase said authorized parking time by any remaining authorized time corresponding to the authorized time linked to said earlier transaction.

The objects, aspects and advantages of the present invention will be better understood from the description given hereinafter of embodiments of the invention, offered by way of non-limiting example, which description is given with reference to the appended drawings, in which:

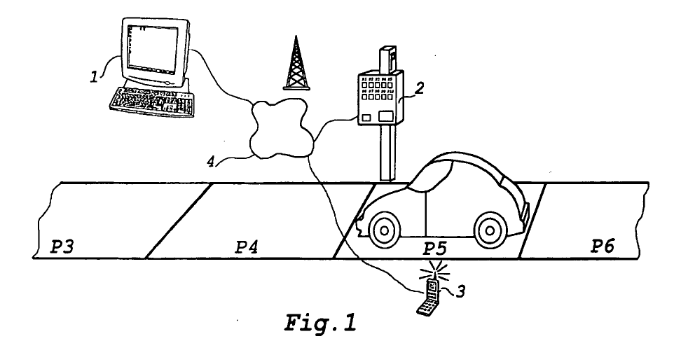

FIG. 1 is a diagram of a system for paying for parking spaces using the method of the invention; and

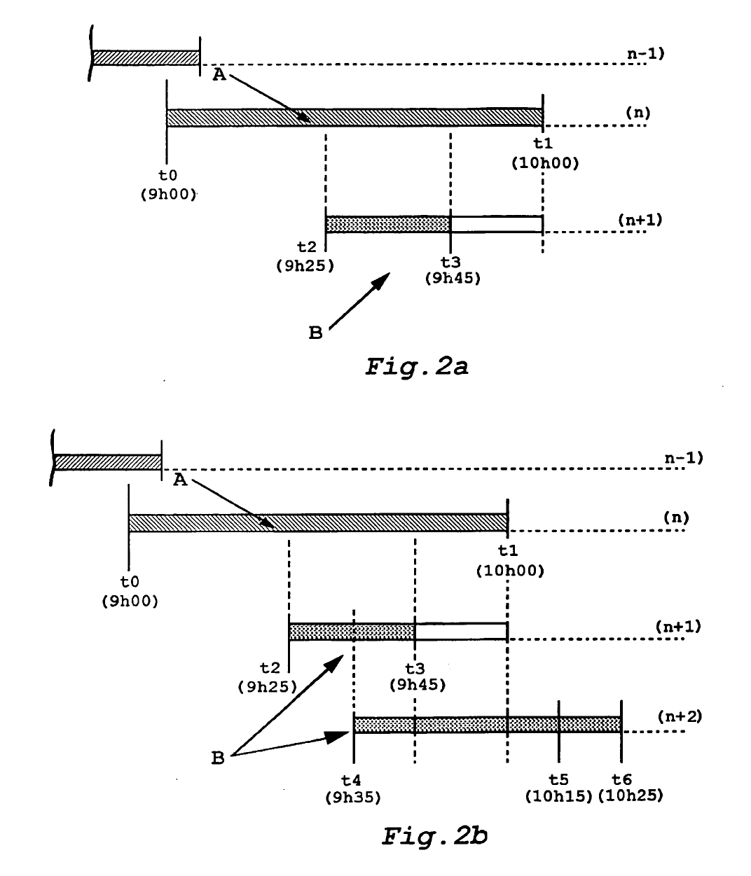

FIGS. 2a and 2b are timing diagrams showing how the method of the present invention determines authorized parking times.

The system shown in FIG. 1 for paying for a parking space is applied to on-street parking, although it can obviously be applied to parking in an enclosed car park. The system includes a payment terminal 2 of the multispace parking meter type connected to a remote server 1 which a user can access by making a telephone call from a telephone 3 via an appropriate network 4 (PSTN, GSM, etc.).

The parking meter 2 is part of a network of terminals regularly distributed along the pavements of streets in which parking is controlled and chargeable, for example every 50 meters. This kind of network, covering a built-up area, is managed by an operator such as a private organization or a municipal authority. The same parking facility may comprise from a few dozen to several thousand terminals, depending on the size of the town or the built-up area concerned. Of course, the use of parking meter type payment terminals is not limiting on the present invention, which relates equally to parking ticket dispensers.

The composition of the payment system represented in FIG. 1 is not limiting on the invention, which may be implemented with a network of terminals operating autonomously, without requiring any remote server to implement the invention, or without terminals, merely a remote server which communicates information relating to payment for parking spaces to portable terminals carried by supervisory operatives.

The payment terminal 2 manages a plurality of parking spaces P3, P4, P5, P6, etc. chosen by pressing a key on a keypad corresponding to the selected space. The user then pays for a predetermined parking time in the parking space identified in this way.

The terminal 2 conventionally comprises a number of means providing the essential functions of a multispace parking meter, that is to say payment means, such as an electronic memory or microcontroller card reader and/or a coin or token handling device, data entry means, such as a keypad or a thumbwheel, associated with a display screen, in particular for selecting a parking space and a parking time, a time generator, electrical power supply means, etc. The terminal 2 further comprises means for visually indicating the status of the spaces managed by the terminal 2. These visual indication means may be placed on the front and/or rear face of the terminal 2, as a function of the disposition of the man/machine interface of the terminal relative to the public way. It is highly advantageous to dispose the visual indication means so that a supervisory operative can tell the payment status of a given space from a vehicle traveling on the public way.

Where appropriate, and in the manner that is known in the art, the terminal 2 also includes printing means such as a thermal printhead, for example, capable of dispensing a ticket indicating the amount paid and the parking expiry time.

A central unit or microcontroller running appropriate software controls the operation of the parking meter and its peripheral devices.

The terminal 2 further includes appropriate communication means enabling exchange of data with the remote server 1. In particular, it is possible to execute operations to pay for parking spaces directly via the server 1 by means of a simple telephone call, the server supplying the payment status of the parking spaces to the supervisory operatives either directly or via the terminal 2.

According to the invention, the microcontroller of the terminal 2 is equipped with a dedicated program adapted to supply and to process a transaction code for optimizing parking time payment both for the user and for the manager of the terminal 2.

FIGS. 2a and 2b show how the invention determines the parking time.

This method is based on the general application of the “Best Time” mode from one transaction to another, except when the same user wishes to extend his parking time, in which case the “Add Time” mode is selected by the code sent to the user after each payment.

Consider a user “A” who has parked in the space P5 and who at the time t0 (9 h00 a.m.) has paid to the terminal 2 or to the server 1 an amount, for example one Euro fifty centimes (1.5ε), for an authorized parking time of one hour, under the applicable parking charge scheme, this period running from the time t0 to the time t1 (10 h00 a.m.). That payment constitutes the n^{th} transaction for the terminal 2. On making the payment, the user “A” receives a parking code associated with the n^{th} transaction, for example “P5-2313”. This code is displayed on the display screen or printed out on a ticket.

The user “A” having left the space P5 well before the end of his authorized parking time, another user “B”, seeing the empty space P5, parks in it. The user “B” goes to the terminal 2 at the time t2 (9 h25 a.m.) (t2<t1), finds that the space is authorized for parking, thanks to a green light corresponding to the space P5, although he does not know the time at which the authorized period expires, pays the amount necessary for the envisaged parking time, for example fifty Euro centimes (0.5ε) for twenty minutes of authorized parking running from the time t2 to the time t3 (9 h45 a.m.). On paying, the user “B” receives a parking code associated with this (n+1)^{th} transaction, for example “P5-5489”.

In fact, the user “B” has the benefit of an authorized parking time equal to whichever is the greater of the following:

an authorized time related directly to the payment that the user “B” has just made, i.e. twenty minutes (t3−t2); and

a residual authorized time associated with preceding transactions, in this instance thirty-five minutes (t1−t2).

In the example shown, the user “B” therefore has the benefit of the period t1−t2 since this is greater than the period t3−t2.

Note that the user “B” knows a priori only the period for which he has paid, i.e. the period t3−t2.

The user “B” realizes later that he needs to park for longer than originally intended and comes back at the time t4 (9 h35 a.m.) to make a second payment, for example of one Euro (1ε) for forty minutes of authorized parking from t4 to t5 (10 h15 a.m.); if, when making the new payment, the user “B” enters the code “P5-5489” obtained previously, then the authorized parking time is calculated in the “Add Time” mode, i.e. the authorized time is fifty minutes from t4 to t6 (9 h45 a.m.), i.e. the forty minutes paid for plus the remaining ten minutes (t3−t4) at the time t4 corresponding to the previous authorized period linked to the code “P5-5489”. Obviously, on making this second payment, the user “B” receives a new transaction code “P5-7320” corresponding to this (n+2)^{th} transaction.

In the embodiment described, the user “B” could just as well have extended his authorized parking time without returning to the terminal 2 by calling the server 1 directly from his telephone 3 or any other telephone.

In the embodiment described the chargeable parking spaces are numbered and the payment to the server 1 can be made either by telephone or at the terminal 2.

The user carrying out a transaction receives in return a unique code that is valid until the expiry time of the authorized parking time originally requested.

That code may be shown on the display of the terminal 2, printed by the terminal on a receipt, or communicated by the server 1 via a mobile telephone (voice message, SMS message, etc.) if payment is made by mobile telephone.

The code may where applicable be a unique identifier of the electronic payment means (mobile telephone identifier, bank card number, etc.) or a badge type identifier.

On noticing that the selected parking time is not long enough, he can then extend the current transaction for the space concerned, either remotely or directly at the terminal, provided that he gives the transaction code enabling the transaction to be extended via the selected interface (the mobile telephone or the keypad of the parking terminal). If the code is the identifier of the payment means, the system automatically authorizes extension of the parking time.

Thus the system allows only the same user to extend a current transaction, based on an identifier that is specific to him or known only to him. The system therefore forces the rotation of vehicles.

It complies with maximum parking time constraints for the same transaction, even if the parking time is extended.

This way of extending the parking time has the advantage that if the maximum allowed time is reached the user is obliged to return to the machine to effect a new transaction. One option is to prohibit a second transaction using the same electronic payment means, regardless of its type, remotely or otherwise.

It is also possible to prohibit the use of the same electronic payment means over the whole of a parking area.

This has the advantage of enabling the user to carry out this operation remotely, via his mobile telephone. He can also use the conventional telephone network.

Another user cannot use any remaining time as he does not know the code linked to the transaction. He must therefore effect a standard transaction, with the parking time calculated from the time at which the payment is effected.

1. Method of paying for a parking space using a payment system including appropriate payment means, whereby the user pays a given amount to benefit from a corresponding authorized parking time, said method comprising the steps of:
cooperating between said payment means and an appropriate processing and communication means for supplying to said user a code specific to the transaction; and
cooperating between said payment means and an appropriate processing and input means whereby the user can enter the code of an earlier transaction and thereby increase said authorized parking time by any residual authorized time corresponding to the authorized time linked to said earlier transaction.

2. Parking space payment method according to claim 1, wherein said parking space is identified by an appropriate number and the user must enter said number during the payment operation using the appropriate input and processing means cooperating with said payment means.

3. Parking space payment method according to claim 2, wherein said number is used by said processing means to generate said specific code of the transaction.

4. Parking space payment method according to claim 2, wherein said authorized parking time is increased by any remaining authorized time corresponding to the authorized time linked to said earlier transaction code entered by the user only if said earlier transaction relates to the same parking space.

5. Parking space payment method according to claim 2, wherein the authorized time corresponding to a given amount paid by a user is equal to the greater of the following times: the time directly related to said payment, as defined in particular by an appropriate table of charges, and any remaining authorized time corresponding to the previous authorized time relating to said parking space.

6. Parking space payment method according to claim 2, wherein the authorized time corresponding to a given amount paid by a user is equal to the greater of the following times: the time directly related to said payment as defined in particular by an appropriate table of charges and any remaining authorized times corresponding to preceding authorized times relating to said parking space.

7. Parking space payment method according to claim 5, wherein only the time directly related to said payment as defined in particular by an appropriate table of charges is communicated to the user by appropriate communication means cooperating with said payment means.

8. Parking space payment method according to claim 5, wherein the authorized parking time after the user enters the code of an earlier transaction is equal to the greater of the following times: the time directly related to said payment, as defined in particular by an appropriate table of charges, plus any remaining authorized time corresponding to the authorized time linked to said earlier transaction, and any remaining authorized time corresponding to the previous authorized time relating to said parking space.

9. Parking space payment method according to claim 6, wherein the authorized parking time after the user enters the code of an earlier transaction is equal to the greater of the following times: the time directly related to said payment, as defined in particular by an appropriate table of charges, plus any remaining authorized time corresponding to the authorized time linked to said earlier transaction, and any remaining authorized times corresponding to previous authorized times relating to said parking space.

10. Parking space payment system including appropriate payment means whereby a user pays a given amount to benefit from a corresponding authorized parking time, said system comprising:
payment means cooperating with appropriate processing and communication means to supply to said user a code specific to the transaction; and
wherein said payment means cooperates with appropriate processing and input means whereby the user can enter the code of an earlier transaction and thereby increase said authorized parking time by any remaining authorized time corresponding to the authorized time linked to said earlier transaction.
